(19) United States
(12) Patent Application Publication
(10) Pub. No.: US 2022/0365231 A1
(43) Pub. Date: Nov. 17, 2022

(54) IMAGING SYSTEMS AND METHODS OF OPERATING THE SAME

(71) Applicant: SHENZHEN XPECTVISION TECHNOLOGY CO., LTD., Shenzhen (CN)

(72) Inventor: Peiyan CAO, Shenzhen (CN)

(21) Appl. No.: 17/859,375

(22) Filed: Jul. 7, 2022

Related U.S. Application Data
(63) Continuation of application No. PCT/CN2020/076784, filed on Feb. 26, 2020.

(51) Int. Cl. G01T 1/24; G01K 1/02

(52) U.S. Cl. CPC G01T 1/24; G01K 1/026

(57) ABSTRACT

Disclosed herein is a method, comprising: for i=1, . . . , N, exposing a pixel (i) of a same radiation detector to a radiation (i) thereby causing an apparent signal (i) in the pixel (i), wherein the pixel (i) is at a temperature (i) at the time the pixel (i) is exposed to the radiation (i); for i=1, . . . , N, determining the temperature (i) of the pixel (i); and for i=1, . . . , N, determining an actual value (i) of a same radiation characteristic of the radiation (i) based on the apparent signal (i) and the temperature (i), wherein N is a positive integer. The radiation characteristic may be radiation intensity, radiation phase, or radiation polarization.

### TECHNICAL FIELD

The disclosure herein relates to radiation detectors.

### BACKGROUND

A radiation detector is a device that measures a property of a radiation. Examples of the property may include a spatial distribution of the intensity, phase, and polarization of the radiation. The radiation may be one that has interacted with an object. For example, the radiation measured by the radiation detector may be a radiation that has penetrated the object. The radiation may be an electromagnetic radiation such as infrared light, visible light, ultraviolet light, X-ray or y-ray. The radiation may be of other types such as α-rays and β-rays. The radiation may comprise radiation particles such as photons (electromagnetic waves) and subatomic particles.

### SUMMARY

Disclosed herein is a method comprising: for i=1, . . . , N, exposing a pixel (i) of a same radiation detector to a radiation (1,i), thereby causing an apparent signal (1,i) in the pixel (i), wherein the pixel (i) is at a temperature (1,i) at the time the pixel (i) is exposed to the radiation (1,i); for i=1, . . . , N, determining the temperature (1,i) of the pixel (i); and for i=1, . . . , N, determining an actual intensity (1,i) of the radiation (1,i) based on the apparent signal (1,i) and the temperature (1,i), wherein N is a positive integer.

According to an embodiment, N is greater than 1.

According to an embodiment, the method further comprises: for i=1, . . . , N, exposing the pixel (i) to a radiation (2,i) thereby causing an apparent signal (2,i) in the pixel (i), wherein the pixel (i) is at a temperature (2,i) at the time the pixel (i) is exposed to the radiation (2,i); for i=1, . . . , N, determining the temperature (2,i) of the pixel (i); and for i=1, . . . , N, determining an actual intensity (2,i) of the radiation (2,i) based on the apparent signal (2,i) and the temperature (2,i).

According to an embodiment, said determining the temperatures (1,i), i=1, . . . , N comprises measuring the temperatures (1,i), i=1, . . . , N using Q thermometers positioned across the radiation detector, and Q is a positive integer.

According to an embodiment, Q=N, and the Q thermometers are positioned one-to-one at the pixels (i), i=1, . . . , N.

According to an embodiment, Q<N, and said determining the temperatures (1,i), i=1, . . . , N involves interpolation.

According to an embodiment, the method further comprises for i=1, . . . , N, determining a relationship (i) between (A) an actual intensity (i) of a radiation (i) incident on the pixel (i), (B) an apparent signal (i) caused by the radiation (i) in the pixel (i), and (C) a temperature (i) of the pixel (i) at the time the radiation (i) is incident on the pixel (i), wherein for i=1, . . . , N, said determining the actual intensity (1,i) is performed using the relationship (i).

According to an embodiment, said determining the relationships (i), i=1, . . . , N comprises: for i=1, . . . , N, specifying a general formula (i) of the actual intensity (i) in terms of the apparent signal (i) and the temperature (i), each of the general formulas (i), 1=1, . . . , N having M coefficients resulting in M×N coefficients, wherein M is a positive integer; obtaining empirical data of the actual intensity (i), the apparent signal (i), and the temperature (i), for i=1, . . . , N; plugging the empirical data into the general formulas (i), i=1, . . . , N resulting in M×N equations of the M×N coefficients; solving the M×N equations for values of the M×N coefficients; and plugging the values of the M×N coefficients into the general formulas (i), 1=1, . . . , N resulting in specific formulas (i), i=1, . . . , N, of the actual intensities (i), i=1, . . . , N in terms of the apparent signals (i), i=1, . . . , N and the temperatures (i), i=1, . . . , N respectively, and wherein for i=1, . . . , N, said using the relationship (i) comprises using the specific formula (i).

According to an embodiment, said determining the relationships (i), i=1, . . . , N comprises obtaining empirical data of the actual intensity (i), the apparent signal (i), and the temperature (i), for i=1, . . . , N by exposing the pixels (i), i=1, . . . , N, to M radiations of known intensity.

According to an embodiment, each radiation of the M radiations has uniform intensity throughout the pixels (i), i=1, . . . , N.

According to an embodiment, a radiation of the M radiations has zero intensity throughout the pixels (i), i=1, . . . , N.

According to an embodiment, said determining the temperatures (1,i), i=1, . . . , N comprises: for i=1, . . . , N, exposing the pixel (i) to a radiation (3,i) with a known actual intensity (3,i), thereby causing an apparent signal (3,i) in the pixel (i); for i=1, . . . , N, determining a temperature (3,i) of the pixel (i) based on the actual intensity (3,i) and the apparent signal (3,i), using the relationship (i); and for i=1, . . . , N, using the temperature (3,i) as a value of the temperature (1,i).

According to an embodiment, said exposing the pixel (i) to the radiation (3,i) is performed essentially immediately before or essentially immediately after said exposing the pixel (i) to the radiation (1,i) is performed.

Disclosed herein is a method, comprising: for i=1, . . . , N, exposing a pixel (i) of a same radiation detector to a radiation (1,i) thereby causing an apparent signal (1,i) in the pixel (i), wherein the pixel (i) is at a temperature (1,i) at the time the pixel (i) is exposed to the radiation (1,i); for i=1, . . . , N, determining the temperature (1,i) of the pixel (i); and for i=1, . . . , N, determining an actual value (1,i) of a same radiation characteristic of the radiation (1,i) based on the apparent signal (1,i) and the temperature (1,i), wherein N is a positive integer.

According to an embodiment, the radiation characteristic is radiation intensity, radiation phase, or radiation polarization.

According to an embodiment, N is greater than 1.

According to an embodiment, the method further comprises: for i=1, . . . , N, exposing the pixel (i) to a radiation (2,i) thereby causing an apparent signal (2,i) in the pixel (i), wherein the pixel (i) is at a temperature (2,i) at the time the pixel (i) is exposed to the radiation (2,i); for i=1, . . . , N, determining the temperature (2,i) of the pixel (i); and for i=1, . . . , N, determining an actual value (2,i) of the radiation characteristic of the radiation (2,i) based on the apparent signal (2,i) and the temperature (2,i).

According to an embodiment, said determining the temperatures (1,i), i=1, . . . , N comprises measuring the temperatures (1,i), i=1, . . . , N using Q thermometers positioned across the radiation detector, and Q is a positive integer.

According to an embodiment, Q=N, and the Q thermometers are positioned one-to-one at the pixels (i), i=1, . . . , N.

According to an embodiment, Q<N, and said determining the temperatures (1,i), i=1, . . . , N involves interpolation.

According to an embodiment, the method further comprises for i=1, . . . , N, determining a relationship (i) between (A) an actual value (i) of the radiation characteristic of a radiation (i) incident on the pixel (i), (B) an apparent signal (i) caused by the radiation (i) in the pixel (i), and (C) a temperature (i) of the pixel (i) at the time the radiation (i) is incident on the pixel (i), wherein for i=1, . . . , N, said determining the actual value (1,i) is performed using the relationship (i).

According to an embodiment, said determining the relationships (i), i=1, . . . , N comprises: for i=1, . . . , N, specifying a general formula (i) of the actual value (i) in terms of the apparent signal (i) and the temperature (i), each of the general formulas (i), 1=1, . . . , N having M coefficients resulting in M×N coefficients, wherein M is a positive integer; obtaining empirical data of the actual value (i), the apparent signal (i), and the temperature (i), for i=1, . . . , N; plugging the empirical data into the general formulas (i), i=1, . . . , N resulting in M×N equations of the M×N coefficients; solving the M×N equations for values of the M×N coefficients; and plugging the values of the M×N coefficients into the general formulas (i), 1=1, . . . , N resulting in specific formulas (i), i=1, . . . , N, of the actual values (i), i=1, . . . , N in terms of the apparent signals (i), i=1, . . . , N and the temperatures (i), i=1, . . . , N respectively, and wherein for i=1, . . . , N, said using the relationship (i) comprises using the specific formula (i).

According to an embodiment, said determining the relationships (i), i=1, . . . , N comprises obtaining empirical data of the actual value (i), the apparent signal (i), and the temperature (i), for i=1, . . . , N by exposing the pixels (i), i=1, . . . , N, to M radiations of known value of the radiation characteristic.

According to an embodiment, each radiation of the M radiations has uniform value of the radiation characteristic throughout the pixels (i), i=1, . . . , N.

According to an embodiment, a radiation of the M radiations has zero value of the radiation characteristic throughout the pixels (i), i=1, . . . , N.

According to an embodiment, said determining the temperatures (1,i), i=1, . . . , N comprises: for i=1, . . . , N, exposing the pixel (i) to a radiation (3,i) with a known actual value (3,i) of the radiation characteristic, thereby causing an apparent signal (3,i) in the pixel (i); for i=1, . . . , N, determining a temperature (3,i) of the pixel (i) based on the actual value (3,i) and the apparent signal (3,i), using the relationship (i); and for i=1, . . . , N, using the temperature (3,i) as a value of the temperature (1,i).

According to an embodiment, said exposing the pixel (i) to the radiation (3,i) is performed essentially immediately before or essentially immediately after said exposing the pixel (i) to the radiation (1,i) is performed.

### BRIEF DESCRIPTION OF FIGURES

FIG. 1 schematically shows a radiation detector, according to an embodiment.

FIG. 2A schematically shows a simplified cross-sectional view of the radiation detector.

FIG. 2B schematically shows a detailed cross-sectional view of the radiation detector.

FIG. 2C schematically shows an alternative detailed cross-sectional view of the radiation detector.

FIG. 3 schematically shows an imaging system, according to an embodiment.

FIG. 4 shows a flowchart summarizing the operation of the imaging system, according to an embodiment.

FIG. 5 shows another flowchart summarizing and generalizing the operation of the imaging system, according to an embodiment.

### DETAILED DESCRIPTION

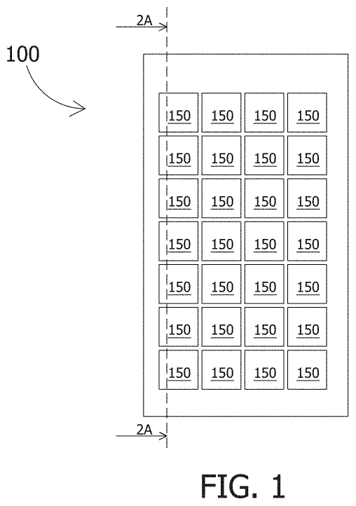

FIG. 1 schematically shows a radiation detector 100, as an example. The radiation detector 100 may include an array of pixels 150. The array may be a rectangular array (as shown in FIG. 1), a honeycomb array, a hexagonal array or any other suitable array. The array of pixels 150 in the example of FIG. 1 has 4 rows and 7 columns; however, in general, the array of pixels 150 may have any number of rows and any number of columns.

Each pixel 150 may be configured to detect radiation from a radiation source incident thereon and may be configured to measure a characteristic (e.g., the energy of the particles, the wavelength, the radiant flux, and the frequency) of the radiation. For example, each pixel 150 may be configured to count numbers of particles of radiation incident thereon whose energy falls in a plurality of bins of energy, within a period of time. All the pixels 150 may be configured to count the numbers of particles of radiation incident thereon within a plurality of bins of energy within the same period of time. When the incident particles of radiation have similar energy, the pixels 150 may be simply configured to count numbers of particles of radiation incident thereon within a period of time, without measuring the energy of the individual particles.

Each pixel 150 may have its own analog-to-digital converter (ADC) configured to digitize an analog signal representing the energy of an incident particle of radiation into a digital signal, or to digitize an analog signal representing the total energy of a plurality of incident particles of radiation into a digital signal. The pixels 150 may be configured to operate in parallel. For example, when one pixel 150 measures an incident particle of radiation, another pixel 150 may be waiting for a particle of radiation to arrive. The pixels 150 may not have to be individually addressable.

The radiation detector 100 described here may have applications such as in an X-ray telescope, X-ray mammography, industrial X-ray defect detection, X-ray microscopy or microradiography, X-ray casting inspection, X-ray non-destructive testing, X-ray weld inspection, X-ray digital subtraction angiography, etc. It may be suitable to use this radiation detector 100 in place of a photographic plate, a photographic film, a PSP plate, an X-ray image intensifier, a scintillator, or another semiconductor X-ray detector. The radiation detector 100 may also be used as an image sensor that detects visible light photons containing the image of an object or scene.

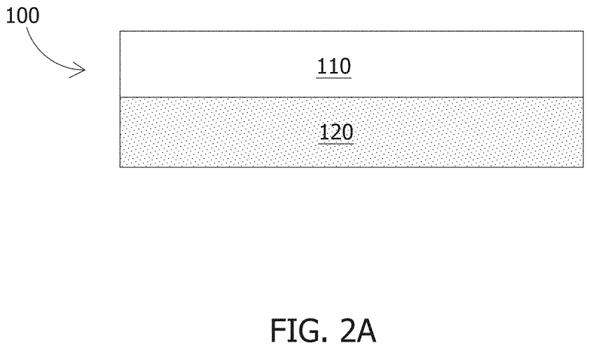

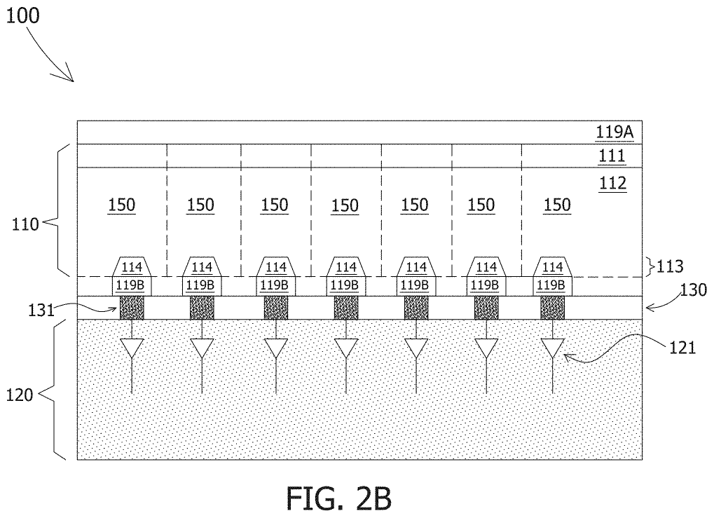

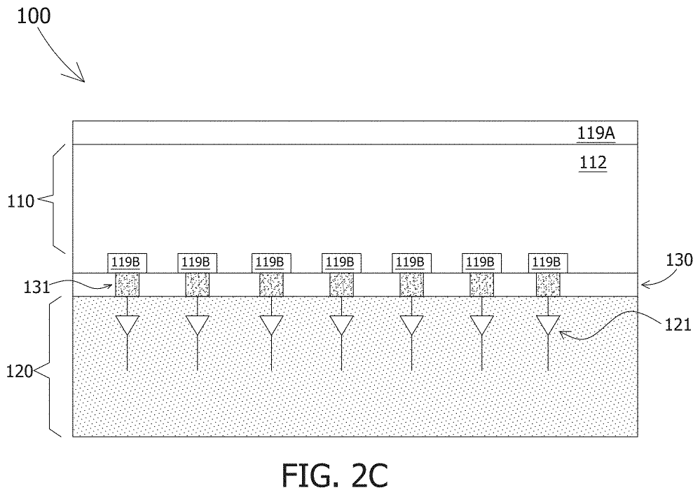

FIG. 2A schematically shows a simplified cross-sectional view of the radiation detector 100 of FIG. 1 along a line 2A-2A, according to an embodiment. More specifically, the radiation detector 100 may include a radiation absorption layer 110 and an electronics layer 120 (e.g., an ASIC) for processing or analyzing electrical signals which incident radiation generates in the radiation absorption layer 110. The radiation detector 100 may or may not include a scintillator (not shown). The radiation absorption layer 110 may include a semiconductor material such as, silicon, germanium, GaAs, CdTe, CdZnTe, or any combinations thereof. The semiconductor material may have a high mass attenuation coefficient for the radiation of interest.

FIG. 2B schematically shows a detailed cross-sectional view of the radiation detector 100 of FIG. 1 along the line 2A-2A, as an example. More specifically, the radiation absorption layer 110 may include one or more diodes (e.g., p-i-n or p-n) formed by a first doped region 111, one or more discrete regions 114 of a second doped region 113. The second doped region 113 may be separated from the first doped region 111 by an optional intrinsic region 112. The discrete regions 114 are separated from one another by the first doped region 111 or the intrinsic region 112. The first doped region 111 and the second doped region 113 have opposite types of doping (e.g., region 111 is p-type and region 113 is n-type, or region 111 is n-type and region 113 is p-type). In the example of FIG. 2B, each of the discrete regions 114 of the second doped region 113 forms a diode with the first doped region 111 and the optional intrinsic region 112. Namely, in the example in FIG. 2B, the radiation absorption layer 110 has a plurality of diodes (more specifically, 7 diodes corresponding to 7 pixels 150 of one row in the array of FIG. 1). The plurality of diodes have an electrode 119A as a shared (common) electrode which may comprise polysilicon. The first doped region 111 may also have discrete portions.

The electronics layer 120 may include an electronic system 121 suitable for processing or interpreting signals generated by the radiation incident on the radiation absorption layer 110. The electronic system 121 may include an analog circuitry such as a filter network, amplifiers, integrators, and comparators, or a digital circuitry such as a microprocessor, and memory. The electronic system 121 may include one or more ADCs. The electronic system 121 may include components shared by the pixels 150 or components dedicated to a single pixel 150. For example, the electronic system 121 may include an amplifier dedicated to each pixel 150 and a microprocessor shared among all the pixels 150. The electronic system 121 may be electrically connected to the pixels 150 by vias 131. Space among the vias may be filled with a filler material 130, which may increase the mechanical stability of the connection of the electronics layer 120 to the radiation absorption layer 110. Other bonding techniques are possible to connect the electronic system 121 to the pixels 150 without using the vias 131.

When radiation from the radiation source (not shown) hits the radiation absorption layer 110 including diodes, the particles of radiation may be absorbed and generate one or more charge carriers (e.g., electrons, holes) by a number of mechanisms. The charge carriers may drift to the electrodes of one of the diodes under an electric field. The field may be an external electric field. The electrical contact 119B may include discrete portions each of which is in electrical contact with the discrete regions 114. The term “electrical contact” may be used interchangeably with the word “electrode.” In an embodiment, the charge carriers may drift in directions such that the charge carriers generated by a single particle of the radiation are not substantially shared by two different discrete regions 114 (“not substantially shared” here means less than 2%, less than 0.5%, less than 0.1%, or less than 0.01% of these charge carriers flow to a different one of the discrete regions 114 than the rest of the charge carriers). Charge carriers generated by a particle of the radiation incident around the footprint of one of these discrete regions 114 are not substantially shared with another of these discrete regions 114. A pixel 150 associated with a discrete region 114 may be an area around the discrete region 114 in which substantially all (more than 98%, more than 99.5%, more than 99.9%, or more than 99.99% of) charge carriers generated by a particle of the radiation incident therein flow to the discrete region 114. Namely, less than 2%, less than 1%, less than 0.1%, or less than 0.01% of these charge carriers flow beyond the pixel 150.

FIG. 2C schematically shows an alternative detailed cross-sectional view of the radiation detector 100 of FIG. 1 along the line 2A-2A, according to an embodiment. More specifically, the radiation absorption layer 110 may include a resistor of a semiconductor material such as, silicon, germanium, GaAs, CdTe, CdZnTe, or a combination thereof, but does not include a diode. The semiconductor material may have a high mass attenuation coefficient for the radiation of interest. In an embodiment, the electronics layer 120 of FIG. 2C is similar to the electronics layer 120 of FIG. 2B in terms of structure and function.

When the radiation hits the radiation absorption layer 110 including the resistor but not diodes, it may be absorbed and generate one or more charge carriers by a number of mechanisms. A particle of the radiation may generate 10 to 100,000 charge carriers. The charge carriers may drift to the electrical contacts 119A and 119B under an electric field. The electric field may be an external electric field. The electrical contact 119B includes discrete portions. In an embodiment, the charge carriers may drift in directions such that the charge carriers generated by a single particle of the radiation are not substantially shared by two different discrete portions of the electrical contact 119B (“not substantially shared” here means less than 2%, less than 0.5%, less than 0.1%, or less than 0.01% of these charge carriers flow to a different one of the discrete portions than the rest of the charge carriers). Charge carriers generated by a particle of the radiation incident around the footprint of one of these discrete portions of the electrical contact 119B are not substantially shared with another of these discrete portions of the electrical contact 119B. A pixel 150 associated with a discrete portion of the electrical contact 119B may be an area around the discrete portion in which substantially all (more than 98%, more than 99.5%, more than 99.9% or more than 99.99% of) charge carriers generated by a particle of the radiation incident therein flow to the discrete portion of the electrical contact 119B. Namely, less than 2%, less than 0.5%, less than 0.1%, or less than 0.01% of these charge carriers flow beyond the pixel associated with the one discrete portion of the electrical contact 119B.

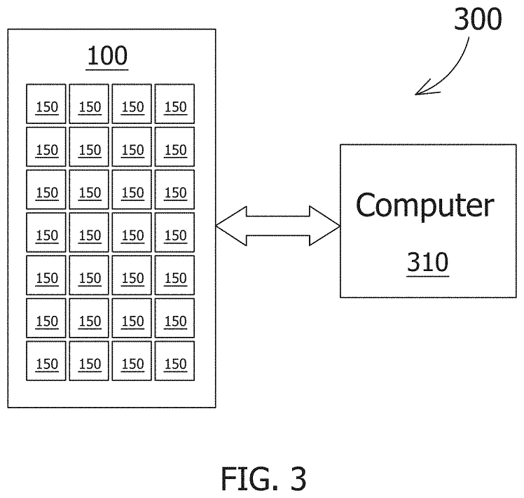

FIG. 3 schematically shows an imaging system 300, according to an embodiment. In an embodiment, the imaging system 300 may include the radiation detector 100 and a computer 310 electrically connected to the radiation detector 100.

In an embodiment, a formula determination process of the imaging system 300 may be performed as follows. The first step may be to specify a radiation characteristic (such as intensity, phase, or polarization, etc.) which the imaging system 300 is used to measure. For example, assume that radiation intensity is specified as the radiation characteristic which the imaging system 300 is used to measure.

Next, in an embodiment, a general formula of actual intensity may be specified for each of the 28 pixels 150. Specifically, for i=1, . . . , 28, the general formula of actual intensity for the pixel (i) may be {Ri=(1+ai×Ti)×Si+bi×Ti} (called formula Fi_abST), wherein Ri is the actual intensity of a radiation (i) incident on the pixel (i); Si is the apparent signal caused by the radiation (i) in the pixel (i); Ti is the temperature of the pixel (i) at the time the pixel (i) is exposed to the radiation (i); and ai and bi are two constant coefficients. It can be said that Fi_abST is a formula of Ri in terms of Si and Ti.

More specifically, the general formula of actual intensity for the pixel (1) may be {R1=(1+a1×T1)×S1+b1×T1} (called formula F1_abST), the general formula of actual intensity for the pixel (2) may be {R2=(1+a2×T2)×S2+b2×T2} (called formula F2_abST), and so on . . . , and the general formula of actual intensity for the pixel (28) may be {R28=(1+a28×T28)×S28+b28×T28} (called formula F28_abST).

Next, in an embodiment, in order to determine the values of the 56 coefficients ai and bi, i=1, . . . , 28 in the 28 general formulas Fi_abST, i=1, . . . , 28, the radiation detector 100 (including the 28 pixels 150) may be brought to a certain temperature, for example, T1=T2= . . . =T28=25. The specific values used in this description (e.g., 25 for temperature) are just for illustration and are not meant to be realistic (hence no units are indicated).

Next, in an embodiment, while the 28 pixels 150 are at that temperature (i.e., T1=T2= . . . =T28=25), the 28 pixels 150 may be exposed to a first radiation of known actual intensity for each pixel 150, for example, R1=R2= . . . =R28=20 thereby causing 28 apparent signals S1, S2, . . . , and S28 in the pixel (1), pixel (2), . . . , and pixel (28), respectively. The 28 values of these 28 apparent signals S1, S2, . . . , and S28 may be read by the electronics layer 120 of the radiation detector 100 and then may be transferred to the computer 310 for later processing.

Assume that R1=R2= . . . =R28=20 at T1=T2= . . . =T28=25 as mentioned above results in S1=51, S2=52, . . . , and S28=53 (only 3 specific values of 51, 52, and 53 are provided for the pixel (1), pixel (2), and pixel (28) respectively to simplify the description). These 28 empirical data points of R, S, and T may be plugged into the 28 general formulas F1_abST, F2_abST, . . . , and F28_abST described above resulting in 28 equations of the 56 coefficients ai and bi, i=1, . . . , 28 namely: {20=(1+25a1)×51+25b1} (called equation E1A), {20=(1+25a2)×52+25b2} (called equation E2A), . . . , and {20=(1+25a28)×53+25b28} (called equation E28A), respectively.

Next, in an embodiment, while the 28 pixels 150 are still at that temperature (i.e., T1=T2= . . . =T28=25), the 28 pixels 150 may be exposed to a second radiation of known actual intensity for each pixel 150, for example, R1=R2= . . . =R28=0 (i.e., the second radiation is total darkness with no incident radiation for each of the 28 pixels 150) thereby causing 28 apparent signals S1, S2, . . . , and S28 in the pixel (1), pixel (2), . . . , and pixel (28), respectively. The 28 values of these 28 apparent signals S1, S2, . . . , and S28 may be read by the electronics layer 120 of the radiation detector 100 and then may be transferred to the computer 310 for later processing.

Assume that R1=R2= . . . =R28=0 at T1=T2= . . . =T28=25 as described above results in S1=41, S2=43, . . . , and S28=45 (only 3 specific values of 41, 43, and 45 are provided for the pixel (1), pixel (2), and pixel (28) respectively to simplify the description). These 28 empirical data points of R, S, and T may be plugged into the general formulas F1_abST, F2_abST, . . . , and F28_abST described above resulting in 28 equations of the 56 coefficients ai and bi, i=1, . . . , 28, namely: {0=(1+25a1)×41+25b1} (called equation E1B), {0=(1+25a2)×43+25b2} (called equation E2B), . . . , and {0=(1+25a28)×45+25b28} (called equation E28B), respectively.

Next, in an embodiment, the system of 2 linear equations E1A and E1B of two unknowns a1 and b1 described above (i.e., {20=(1+25a1)×51+25b1} and {0=(1+25a1)×41+25b1}) may be solved for a1 and b1 resulting in a1=0.04, and b1=−3.28. These specific values of a1 and b1 may be plugged into the general formula F1_abST for the pixel (1) described above resulting in a specific formula of actual intensity {R1=(1+0.04×T1)×S1−3.28×T1} (called formula F1_ST) for the pixel (1).

Similarly, in an embodiment, the system of 2 linear equations E2A and E2B of two unknowns a2 and b2 described above (i.e., {20=(1+25a1)×52+25b1} and {0=(1+25a1)×43+25b1}) may be solved for a2 and b2 resulting in a2=0.05, and b2=−3.82. These specific values of a2 and b2 may be plugged into the general formula F2_abST for the pixel (2) described above resulting in a specific formula of actual intensity {R2=(1+0.05×T2)×S2−3.82×T2} (called formula F2_ST) for the pixel (2).

Similarly, in an embodiment, the system of 2 linear equations E28A and E28B of two unknowns a28 and b28 described above (i.e., {20=(1+25a28)×53+25b28} and {0=(1+25a28)×45+25b28}) may be solved for a28 and b28 resulting in a28=0.06, and b28=−4.5. These specific values of a28 and b28 may be plugged into the general formula F28_abST for the pixel (28) described above resulting in a specific formula of actual intensity {R28=(1+0.06×T28)×S28−4.5×T28} (called formula F28_ST) for the pixel (28).

The 25 specific formulas of actual intensity for the remaining 25 pixels 150 (i.e., pixel (3), pixel (4), . . . , and pixel (27)) may be determined in a similar manner. As a result of the formula determination process described above, the 28 specific formulas of actual intensity Fi_ST, i=1, . . . , 28 are determined for the 28 pixels 150 of the radiation detector 100.

Next, in an embodiment, after the formula determination process of the imaging system 300 is performed as described above, an imaging process of the imaging system 300 may be performed as follows. Firstly, in an embodiment, the 28 pixels 150 of the radiation detector 100 may be exposed to radiation from an object or scene (i.e., the radiation detector 100 is used to capture an apparent image of the object/scene) resulting in 28 apparent signals S1, S2, . . . , and S28 in the 28 pixels 150. These 28 apparent signals S1, S2, . . . , and S28 in the 28 pixels 150 constitute the apparent image of the object/scene. The 28 values of the 28 apparent signals S1, S2, . . . , and S28 may be obtained for subsequent use in the 28 specific formulas Fi_ST, i=1, . . . , 28.

Next, in an embodiment, the 28 values of Ti, i=1, . . . , 28 may be obtained by using 28 thermometers (not shown) to measure Ti, i=1, . . . , 28. In an embodiment, the 28 thermometers may be positioned one-to-one at the 28 pixels 150. Next, in an embodiment, the 56 specific values of Si and Ti, i=1, . . . , 28 obtained as described above may be plugged into the 28 specific formulas F1_ST, F2_ST, . . . , and F28_ST so as to determine the 28 actual intensities Ri, i=1, . . . , 28 for 28 pixels 150.

It should be noted that the 28 values of Ri, i=1, . . . , 28 constitute an actual image of the scene/object as opposed to the 28 values of Si, i=1, 2, 3 which constitute the apparent image of the scene/object. In the example above, it can be said that the actual image of the scene/object is determined based on the apparent image of the scene/object and the temperatures of the 28 pixels 150 at the time the apparent image is captured, using the 28 specific formulas of actual intensity F1_ST, F2_ST, . . . , and F28_ST.

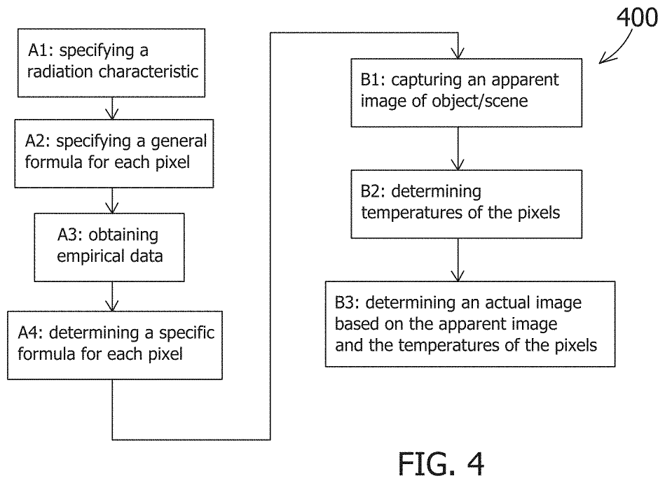

FIG. 4 shows a flow chart 400 summarizing the formula determination process and the imaging process of the imaging system 300 (FIG. 3) according to an embodiment. Specifically, in step A1 of the formula determination process, in an embodiment, a radiation characteristic may be specified. In the example above, radiation intensity is specified.

Next, in step A2 of the formula determination process, in an embodiment, a general formula of actual intensity for each pixel 150 may be specified. In the example above, the general formula of actual intensity for the pixel (i) is {Ri=(1+ai×Ti)×Si+bi×Ti} (i.e., Fi_abST) for i=1, . . . , 28.

Next, in step A3 of the formula determination process, in an embodiment, empirical data may be obtained such that, for i=1, . . . , 28, the number of empirical data points of Ri, Si, and Ti obtained for the pixel (i) is equal to the number M of coefficients in the general formula of actual intensity Ri. In the example above, because {Ri=(1+ai×Ti)×Si+bi×Ti} has 2 coefficients ai and bi (i.e., M=2), two empirical data points of Ri, Si, and Ti for the pixel (i) are obtained. In total, M×N empirical data points of R, S, and T are obtained (wherein M=2, and N=number of pixels=28).

Next, in step A4 of the formula determination process, in an embodiment, a specific formula of radiation intensity may be determined for each pixel 150. Specifically, the empirical data (M×N empirical data points) obtained in step A3 may be plugged into the N general formulas of actual intensity for the N pixels 150 (i.e., Fi_abST, i=1, . . . , N) resulting in M×N equations of M×N coefficients ai and bi, i=1, . . . , N. These M×N equations may be solved for the values of the M×N coefficients (wherein M=2 and N=28 in the example above). These M×N values of the M×N coefficients ai and bi, i=1, . . . , N may be plugged into the N general formulas Fi_abST, i=1, . . . , N resulting in the N specific formulas Fi_ST, i=1, . . . , N of actual intensity for the N pixels 150, respectively (wherein M=2 and N=28 in the example above).

In the example above, for i=1, . . . , 28, the 2 obtained empirical data points of Ri, Si, and Ti for the pixel (i) are plugged into the general formula Fi_abST resulting in 2 equations of ai and bi which are then solved for values of ai and bi. The resulting values of ai and bi are then plugged into the general formula Fi_abST resulting in the specific formula Fi_ST for pixel (i). For instance, F1_ST for the pixel (1) is R1=(1+0.04×T1)×S1−3.28×T1} as described above.

Next, in an embodiment, in step B1 of the imaging process, in an embodiment, an apparent image of the object/scene may be captured using the radiation detector 100. The captured apparent image of the object/scene provides the 28 values of the 28 apparent signals Si, i=1, . . . , 28.

Next, in step B2 of the imaging process, in an embodiment, the 28 temperatures Ti, i=1, . . . , 28 of the 28 pixels 150 may be obtained. In the example above, the 28 values of Ti, i=1, . . . , 28 of the 28 pixels 150 are obtained by using the 28 thermometers at the 28 pixels 150.

Next, in step B3 of the imaging process, in an embodiment, an actual image of the object/scene may be determined based on the captured apparent image of the object/scene and the temperatures of the 28 pixels 150. In the example above, the 28 values of Ri, i=1, . . . , 28 are determined using the 28 specific formulas Fi_ST, i=1, . . . , 28 respectively. The 28 values of Ri, i=1, . . . , 28 for the 28 pixels 150 constitute the actual image of the object/scene.

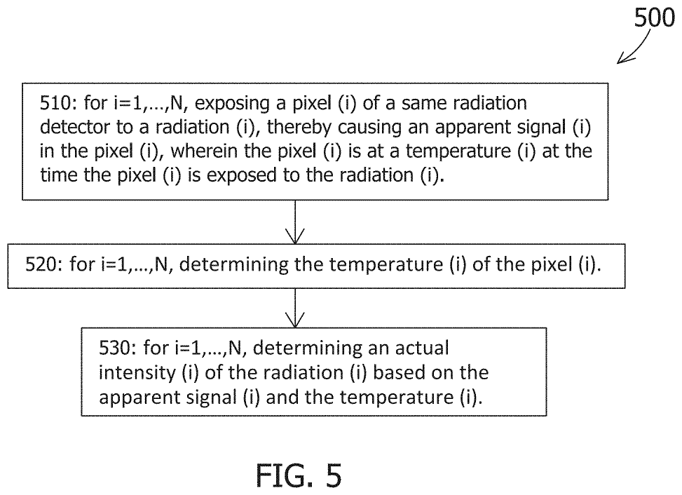

FIG. 5 shows a flowchart 500 summarizing and generalizing the imaging process of the imaging system 300 (FIG. 3) according to an embodiment. In step 510, for i=1, . . . , N (N is a positive integer), a pixel (i) of the radiation detector 100 may be exposed to a radiation (i), thereby causing an apparent signal (i) in the pixel (i), wherein the pixel (i) is at a temperature (i) at the time the pixel (i) is exposed to the radiation (i). In step 520, for i=1, . . . , N, the temperature (i) of the pixel (i) may be determined. In an embodiment, the temperatures (i), i=1, . . . , N may be determined by using N thermometers positioned one-to-one at the pixels (i), i=1, . . . , N. In step 530, for i=1, . . . , N, an actual intensity (i) of the radiation (i) may be determined based on the apparent signal (i) and the temperature (i). The N actual intensities (i), i=1, . . . , N constitute the actual image of the object/scene.

In the embodiments described above, the formula determination process and the imaging process are described for the case the radiation detector 100 has 28 pixels 150. In general, the formula determination process and the imaging process described above may readily be used for the case where the radiation detector 100 has any number of pixels 150.

In the embodiments described above, radiation intensity is the radiation characteristic of interest. In general, any radiation characteristic (such as intensity, phase, or polarization, etc.) may be specified as the radiation characteristic of interest.

In the embodiments described above, for the pixel (i), the specific formula of actual intensity Fi_ST are used to express the relationship between Ri, Si, and Ti (e.g., {R1=(1+0.04×T1)×S1−3.28×T1} for pixel (1)). In general, any relationship form (e.g., formulas, lookup tables, graphs, plots, etc.) may be used to express the relationship between Ri, Si, and Ti for the pixel (i).

In the embodiments described above, the general formula of actual radiation intensity for a pixel 150 has the formula form of {l=(1+aT)S+bT}. In general, the general formula of actual radiation intensity for a pixel 150 may have any formula form that expresses R in terms of S and T and some constant coefficients. With sufficient empirical data points of R, S, and T obtained during the formula determination process (step A3 of FIG. 4), these constant coefficients may be determined, and therefore a specific formula for determining actual radiation intensity R in terms of apparent signal S and temperature T may be determined for each of the 28 pixels 150 (step A4 of FIG. 4).

In the embodiments described above, in step A3 (FIG. 4), the two chosen known radiations have uniform intensity through out the 28 pixels 150 (i.e., R1=R2= . . . =R28=20 for the first chosen known radiation and R1=R2= . . . =R28=0 for the second chosen known radiation). In general, the 28 values of Ri, i=1, . . . , 28 of a chosen known radiation do not have to be the same.

In the embodiments described above, in step B2 (FIG. 4), a thermometer positioned at each pixel of the 28 pixels 150 is used to determine the temperature of the pixel at the time the apparent image is captured. In an alternative embodiment, fewer thermometers (i.e., the number of thermometers is less than the number of the pixels 150) may be sparsely positioned across the radiation detector 100 and the temperature of each pixel 150 may be inferred by interpolation.

In yet another alternative embodiment, the temperature of each pixel 150 at the time the apparent image is captured may be determined without thermometers as follows. In an embodiment, essentially immediately after or essentially immediately before (note: “essentially immediately” means immediately or almost immediately) the radiation detector 100 is used to capture the apparent image of the object/scene as described above, the 28 pixels 150 of the radiation detector 100 may be exposed to a radiation of known actual intensity (e.g., total darkness with known actual intensity of R1=R2= . . . =R28=0) and the 28 values of 28 resulting Si, i=1, . . . , 28 may be obtained. Next, the 56 values of Ri and Si, i=1, . . . , 28 may be entered into the 28 specific formulas Fi_ST determined in step A4 (FIG. 4) resulting in 28 temperature equations of 28 unknowns Ti, i=1, . . . , 28. These 28 temperature equations of Ti, i=1, . . . , 28 may be solved for the 28 values of Ti, i=1, . . . , 28 which are the temperatures of 28 pixels 150 at the time the 28 pixels are exposed to the known radiation (i.e., total darkness in this example). However, because the time at which the 28 pixels 150 are exposed to the known radiation is really close to the time at which the apparent image of the object/scene is captured, the 28 temperature values obtained by solving the 28 temperature equations above may be used as 28 temperatures of the 28 pixels 150 at the time of the apparent image of the object/scene is captured.

In the embodiments described above, with reference to FIG. 4, step B2 is performed after step B1. In general, if the thermometers are used to determine Ti, i=1, . . . , 28 as described above, then step B2 may be performed essentially at the time of step B1 (i.e., at the same time as step B1, or essentially immediately before or essentially immediately after step B1). If the alternative method (i.e., without thermometers) is used to determine Ti, i=1, . . . , 28 as described above, then step B2 may be performed sufficiently close to the time of step B1 (i.e., essentially immediately before or essentially immediately after step B1).

In the embodiments described above, the steps B1-B3 of FIG. 4 are performed once. In general, the steps B1-B3 of FIG. 4 may be performed multiple times so that multiple actual images of the same object/scene or of different objects/scenes may be determined.

In the embodiments described above, with reference to FIG. 4, the steps are performed in the order of A1, A2, A3, A4, B1, B2, and B3. In an alternative embodiment, the steps may be performed in the order of A1, B1, B2, A2, A3, A4, and B3 wherein the step B2 may be performed using thermometers. Other orders may be possible.

In the embodiments described above, the radiation detector 100 includes 28 pixels 150 arranged in an array of 7 rows and 4 columns. In general, the radiation detector 100 may include N pixels 150 arranged in any way, wherein N is a positive integer.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
for i=1, . . . , N, exposing a pixel (i) of a same radiation detector to a radiation (1,i), thereby causing an apparent signal (1,i) in the pixel (i), wherein the pixel (i) is at a temperature (1,i) at the time the pixel (i) is exposed to the radiation (1,i);
for i=1, . . . , N, determining the temperature (1,i) of the pixel (i); and
for i=1, . . . , N, determining an actual intensity (1,i) of the radiation (1,i) based on the apparent signal (1,i) and the temperature (1,i),
for i=1, . . . , N, determining a relationship (i) between (A) an actual intensity (i) of a radiation (i) incident on the pixel (i), (B) an apparent signal (i) caused by the radiation (i) in the pixel (i), and (C) a temperature (i) of the pixel (i) at the time the radiation (i) is incident on the pixel (i);
wherein for i=1, . . . , N, said determining the actual intensity (1,i) is performed using the relationship (i);
wherein said determining the temperatures (1,i), i=1, . . . , N comprises:
for i=1, . . . , N, exposing the pixel (i) to a radiation (3,i) with a known actual intensity (3,i), thereby causing an apparent signal (3,i) in the pixel (i);
for i=1, . . . , N, determining a temperature (3,i) of the pixel (i) based on the actual intensity (3,i) and the apparent signal (3,i), using the relationship (i); and
for i=1, . . . , N, using the temperature (3,i) as a value of the temperature (1,i);
wherein N is a positive integer.

2. The method of claim 1, wherein N is greater than 1.

3. The method of claim 1, further comprising:
for i=1, . . . , N, exposing the pixel (i) to a radiation (2,i) thereby causing an apparent signal (2,i) in the pixel (i), wherein the pixel (i) is at a temperature (2,i) at the time the pixel (i) is exposed to the radiation (2,i);
for i=1, . . . , N, determining the temperature (2,i) of the pixel (i); and
for i=1, . . . , N, determining an actual intensity (2,i) of the radiation (2,i) based on the apparent signal (2,i) and the temperature (2,i).

4. The method of claim 1,
wherein said determining the temperatures (1,i), i=1, . . . , N comprises measuring the temperatures (1,i), i=1, . . . , N using Q thermometers positioned across the radiation detector, and
wherein Q is a positive integer.

5. The method of claim 4,
wherein Q=N, and
wherein the Q thermometers are positioned one-to-one at the pixels (i), i=1, . . . , N.

6. The method of claim 4,
wherein Q<N, and
wherein said determining the temperatures (1,i), i=1, . . . , N involves interpolation.

7. (canceled)

8. The method of claim 1,
wherein said determining the relationships (i), i=1, . . . , N comprises:
for i=1, . . . , N, specifying a general formula (i) of the actual intensity (i) in terms of the apparent signal (i) and the temperature (i), each of the general formulas (i), 1=1, . . . , N having M coefficients resulting in M×N coefficients, wherein M is a positive integer;
obtaining empirical data of the actual intensity (i), the apparent signal (i), and the temperature (i), for i=1, . . . , N;
plugging the empirical data into the general formulas (i), i=1, . . . , N resulting in M×N equations of the M×N coefficients;
solving the M×N equations for values of the M×N coefficients; and
plugging the values of the M×N coefficients into the general formulas (i), 1=1, . . . , N resulting in specific formulas (i), i=1, . . . , N, of the actual intensities (i), i=1, . . . , N in terms of the apparent signals (i), i=1, . . . , N and the temperatures (i), i=1, . . . , N respectively, and
wherein for i=1, . . . , N, said using the relationship (i) comprises using the specific formula (i).

9. The method of claim 1, wherein said determining the relationships (i), i=1, . . . , N comprises obtaining empirical data of the actual intensity (i), the apparent signal (i), and the temperature (i), for i=1, . . . , N by exposing the pixels (i), i=1, . . . , N, to M radiations of known intensity.

10. The method of claim 9, wherein each radiation of the M radiations has uniform intensity throughout the pixels (i), i=1, . . . , N.

11. The method of claim 10, wherein a radiation of the M radiations has zero intensity throughout the pixels (i), i=1, . . . , N.

12. (canceled)

13. The method of claim 1, wherein said exposing the pixel (i) to the radiation (3,i) is performed essentially immediately before or essentially immediately after said exposing the pixel (i) to the radiation (1,i) is performed.

14. A method, comprising:
for i=1, . . . , N, exposing a pixel (i) of a same radiation detector to a radiation (1,i) thereby causing an apparent signal (1,i) in the pixel (i), wherein the pixel (i) is at a temperature (1,i) at the time the pixel (i) is exposed to the radiation (1,i);
for i=1, . . . , N, determining the temperature (1,i) of the pixel (i); and
for i=1, . . . , N, determining an actual value (1,i) of a same radiation characteristic of the radiation (1,i) based on the apparent signal (1,i) and the temperature (1,i),
for i=1, . . . , N, determining a relationship (i) between (A) an actual value (i) of the radiation characteristic of a radiation (i) incident on the pixel (i), (B) an apparent signal (i) caused by the radiation (i) in the pixel (i), and (C) a temperature (i) of the pixel (i) at the time the radiation (i) is incident on the pixel (i);
wherein for i=1, . . . , N, said determining the actual value (1,i) is performed using the relationship (i);
wherein said determining the temperatures (1,i), i=1, . . . , N comprises:
for i=1, . . . , N, exposing the pixel (i) to a radiation (3,i) with a known actual value (3,i) of the radiation characteristic, thereby causing an apparent signal (3,i) in the pixel (i);
for i=1, . . . , N, determining a temperature (3,i) of the pixel (i) based on the actual value (3,i) and the apparent signal (3,i), using the relationship (i); and
for i=1, . . . , N, using the temperature (3,i) as a value of the temperature (1,i);
wherein N is a positive integer.

15. The method of claim 14, wherein the radiation characteristic is radiation intensity, radiation phase, or radiation polarization.

16. The method of claim 14, wherein N is greater than 1.

17. The method of claim 14, further comprising:
for i=1, . . . , N, exposing the pixel (i) to a radiation (2,i) thereby causing an apparent signal (2,i) in the pixel (i), wherein the pixel (i) is at a temperature (2,i) at the time the pixel (i) is exposed to the radiation (2,i);
for i=1, . . . , N, determining the temperature (2,i) of the pixel (i); and
for i=1, . . . , N, determining an actual value (2,i) of the radiation characteristic of the radiation (2,i) based on the apparent signal (2,i) and the temperature (2,i).

18. The method of claim 14,
wherein said determining the temperatures (1,i), i=1, . . . , N comprises measuring the temperatures (1,i), i=1, . . . , N using Q thermometers positioned across the radiation detector, and
wherein Q is a positive integer.

19. The method of claim 18,
wherein Q=N, and
wherein the Q thermometers are positioned one-to-one at the pixels (i), i=1, . . . , N.

20. The method of claim 18,
wherein Q<N, and
wherein said determining the temperatures (1,i), i=1, . . . , N involves interpolation.

21. (canceled)

22. The method of claim 14,
wherein said determining the relationships (i), i=1, . . . , N comprises:
for i=1, . . . , N, specifying a general formula (i) of the actual value (i) in terms of the apparent signal (i) and the temperature (i), each of the general formulas (i), 1=1, . . . , N having M coefficients resulting in M×N coefficients, wherein M is a positive integer;
obtaining empirical data of the actual value (i), the apparent signal (i), and the temperature (i), for i=1, . . . , N;
plugging the empirical data into the general formulas (i), i=1, . . . , N resulting in M×N equations of the M×N coefficients;
solving the M×N equations for values of the M×N coefficients; and
plugging the values of the M×N coefficients into the general formulas (i), 1=1, . . . , N resulting in specific formulas (i), i=1, . . . , N, of the actual values (i), i=1, . . . , N in terms of the apparent signals (i), i=1, . . . , N and the temperatures (i), i=1, . . . , N respectively, and
wherein for i=1, . . . , N, said using the relationship (i) comprises using the specific formula (i).

23. The method of claim 14, wherein said determining the relationships (i), i=1, . . . , N comprises obtaining empirical data of the actual value (i), the apparent signal (i), and the temperature (i), for i=1, . . . , N by exposing the pixels (i), i=1, . . . , N, to M radiations of known value of the radiation characteristic.

24. The method of claim 23, wherein each radiation of the M radiations has uniform value of the radiation characteristic throughout the pixels (i), i=1, . . . , N.

25. The method of claim 24, wherein a radiation of the M radiations has zero value of the radiation characteristic throughout the pixels (i), i=1, . . . , N.

26. (canceled)

27. The method of claim 14, wherein said exposing the pixel (i) to the radiation (3,i) is performed essentially immediately before or essentially immediately after said exposing the pixel (i) to the radiation (1,i) is performed.
